(19) United States
(12) Patent Application Publication
(10) Pub. No.: US 2007/0111003 A1
(43) Pub. Date: May 17, 2007

(54) ARTICLE WITH MULTILAYER DIAMOND-LIKE CARBON FILM AND METHOD FOR MANUFACTURING THE SAME

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,461

(22) Filed: Aug. 10, 2006

(30) Foreign Application Priority Data
Nov. 11, 2005 (CN) 200510101236.5

(51) Int. Cl. B32B 9/00; C03C 27/00

(52) U.S. Cl. 428/408; 428/457; 428/634

(57) ABSTRACT

An exemplary article with multilayer diamond-like carbon film includes a substrate, an adhesive layer formed on the substrate, a multilayer doped diamond-like carbon film formed on the adhesive layer, and an undoped diamond-like carbon layer formed on the diamond-like carbon film. The adhesive layer is comprised of a material selected from the group consisting of chrome, titanium, silicon, chromium nitride, titanium nitride, and silicon carbide. The diamond-like carbon film includes a number of doped diamond-like carbon layers stacked one on another. Each doped diamond-like carbon layer is comprised of diamond-like carbon and an additive material selected from a group consisting of chrome, titanium, silicon, chromium nitride, titanium nitride, silicon carbide, silicon nitride, and any combination thereof. A content of the additive material in each doped diamond-like carbon layer gradually decreases with increasing distance away from the substrate. The overcoat has higher corrosion resistance, low friction coefficient, and good wear resistance.

### CROSS-REFERENCE TO RELATED APPLICATIONS

This application is related to commonly-assigned copending applications, Ser. No. 11/309,308, entitled, “ARTICLE WITH MULTILAYER DIAMOND-LIKE CARBON FILM”, filed Jul. 25, 2006, and “ARTICLE WITH MULTILAYER DIAMOND-LIKE CARBON FILM”, filed XXXX (Attorney. Docket No. US9083). Disclosures of the above identified applications are incorporated herein by reference.

### TECHNICAL FIELD

The present invention relates to articles with multilayer diamond-like carbon film, and more particularly to an article with multilayer diamond-like carbon film that has high corrosion resistance, low friction coefficient and good wear resistance, and a method for manufacturing the article.

### BACKGROUND

Diamond-like carbon films have characteristics similar to those of diamond, such as hardness, low friction coefficient, and high chemical stability. Therefore, diamond-like carbon films are used in articles such as molds, or as protective films for improving corrosion and wear resistance. The diamond-like carbon film on the mold is general a single layer, and is formed by the direct current sputtering process. This kind of diamond-like carbon film has poor wear resistance. When being used many times, the diamond-like carbon film can easily be rubbed off from the mold surface, leaving the mold with low corrosion resistance and bad wear resistance.

What is needed, therefore, is an article with multilayer diamond-like carbon film that has high corrosion resistance, low friction coefficient and good wear resistance, and a method for manufacturing the article.

### SUMMARY

In an embodiment, an article with multilayer diamond-like carbon film is provided. The article includes a substrate, an adhesive layer formed on the substrate, a multilayer doped diamond-like carbon film formed on the adhesive layer, and an undoped diamond-like carbon layer formed on the diamond-like carbon film. The adhesive layer is comprised of a material selected from the group consisting of chrome, titanium, silicon, chromium nitride, titanium nitride, and silicon carbide. The multilayer doped diamond-like carbon film includes a number of doped diamond-like carbon layers stacked one on another. Each doped diamond-like carbon layer is comprised of diamond-like carbon and an additive material selected from a group consisting of chrome, titanium, silicon, chromium nitride, titanium nitride, silicon carbide, silicon nitride, and any combination thereof. A content of the additive material in each diamond-like carbon layer gradually decreases with increasing distance away from the substrate.

In another embodiment, a method for manufacturing an article is provided. The method includes the steps of: providing a substrate; forming an adhesive layer on the substrate, the adhesive layer being comprised of a material selected from the group consisting of chrome, titanium, silicon, chromium nitride, titanium nitride, and silicon carbide; forming a multilayer doped diamond-like carbon film on the adhesive layer; the multilayer doped diamond-like carbon film comprising a plurality of doped diamond-like carbon layers stacked one on another, each doped diamond-like carbon layer being comprised of diamond-like carbon and an additive material selected from a group consisting of chrome, titanium, silicon, chromium nitride, titanium nitride, silicon carbide, silicon nitride, and any combination thereof; a content of the additive in each diamond-like carbon layer gradually decreasing with increasing distance away from the substrate; forming an undoped diamond-like carbon layer on the multilayer doped diamond-like carbon film.

Other advantages and novel features will become more apparent from the following detailed description of the present article with multilayer diamond-like carbon film and method for manufacturing the same when taken in conjunction with the accompanying drawings.

### BRIEF DESCRIPTION OF THE DRAWINGS

Many aspects of the article with multilayer diamond-like carbon film and method for manufacturing the same can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic view of a multilayer diamond-like carbon film formed on a substrate, in accordance with a preferred embodiment; and

FIG. 2 is a flowchart of a method for manufacturing the article in FIG. 1, in accordance with another preferred embodiment.

### DETAILED DESCRIPTION OF PREFERRED EMBODIMENTS

Reference will now be made to the drawing figures to describe the preferred embodiments of the present article with multilayer diamond-like carbon film and method for manufacturing the same in detail.

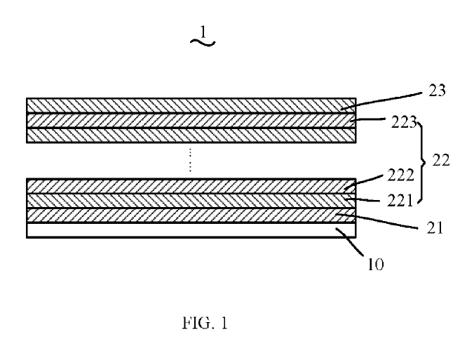

Referring to FIG. 1, an article 1 in accordance with a preferred embodiment is shown. The article 1 includes a substrate 10, an adhesive layer 21, a multilayer doped diamond-like carbon film 22, and undoped diamond-like carbon layer 23. The adhesive layer 21 is formed on the substrate 10, the multilayer doped diamond-like carbon film 22 is formed on the adhesive layer 21, and the undoped diamond-like layer 23 is formed on the multilayer doped diamond-like carbon film 22.

A thickness of the adhesive layer 21 is in the range from 5 nanometers to 20 nanometers. The material of the adhesive layer 21 is selected from the group consisting of chrome, titanium, silicon, chromium nitride, titanium nitride, silicon carbide, and silicon nitride. The adhesive layer 21 adheres to the substrate 10. A thickness of the undoped diamond-like carbon layer 23 is in the range from 2 nanometers to 20 nanometers.

The multilayer doped diamond-like carbon film 22 is sandwiched between the adhesive layer 21 and the undoped diamond-like carbon layer 23. The multilayer doped diamond-like carbon film 22 is composed of N layers of doped diamond-like carbon layer, i.e. a first layer 221, a second layer 222 and so on to an Nth layer 223 stacked one on top of the other in that order, wherein N is an integer, preferably in a range from 5 to 30. The first layer 221 is formed on the adhesive layer 21, the second layer 222 is formed on the first layer 221, and the Nth layer 223 is formed on an (N−1)th layer. The Nth layer 223 is the outermost layer of the multilayer doped diamond-like carbon film 22 and is distant from the substrate 10. The undoped diamond-like carbon layer 23 is formed on the Nth layer 223. A thickness of each doped diamond-like carbon layer is in the range from 2 nanometers to 60 nanometers. Each doped diamond-like carbon layer of the multilayer doped diamond-like carbon film 22 is composed of diamond-like carbon and an additive material. The additive material is selected from the group consisting of chrome, titanium, silicon, chromium nitride, titanium nitride, silicon carbide, silicon nitride, and any combination thereof.

The additive material in each doped diamond-like carbon layer gradually decreases in content from the first layer 221 to the Nth layer 223. For example, molar percentage of the additive of an Mth doped diamond-like carbon layer is (N−M+1)(X, wherein X is in the range from 0.2% to 1%, and M is in the range from 1 to N.

The molar percentage of the additive material in the first layer 221 is the greatest and the Nth layer 223 has least percentage of the additive material. The additive material can enhance binding force of atoms of the doped diamond-like carbon layers. Therefore, the first layer 221 has higher corrosion resistance and a good binding force with the adhesive film 21. With the gradual reducing content of the additive material, the doped diamond-like carbon layers of the multilayer doped diamond-like carbon film 22 have a lower binding force, low friction coefficient, and good wear resistance.

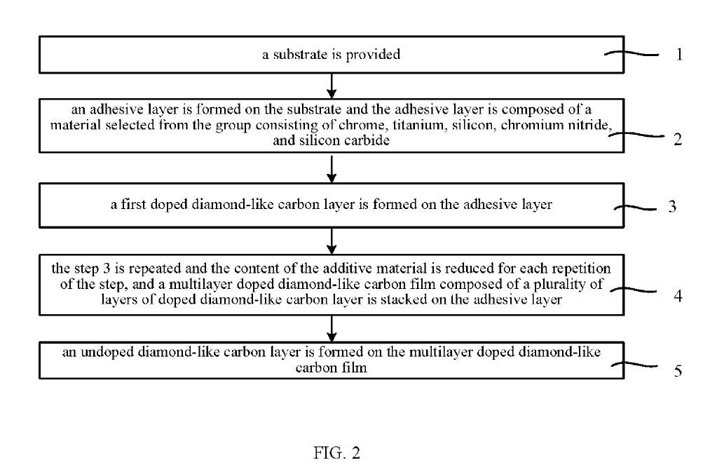

Referring to FIG. 2, a method for manufacturing the article 1 with another preferred embodiment is shown.

In the step 1, a substrate is provided. The material of the substrate is selected from the group consisting of iron-carbon-chrome alloy, iron-carbon-chrome-molybdenum alloy, and iron-carbon-chrome-vanadium alloy. The surface of the substrate undergoes mirror polishing. The roughness of the surface is less than 10 nanometers.

In step 2, an adhesive layer is formed on the substrate and the adhesive layer is composed of a material selected from the group consisting of chrome, titanium, silicon, chromium nitride, and silicon carbide. The adhesive layer is applied by ion beam sputtering.

In step 3, a first doped diamond-like carbon layer is formed on the adhesive layer. The doped diamond-like carbon layer is comprised of diamond-like carbon and an additive material. In this step, two targets are used. A first target is used to sputter the diamond-like carbon and at the same time a second target is used to sputter the additive material. The material of the first target is graphite or carbon. The material of the second target is selected from the group consisting of chrome, titanium, silicon, chromium nitride, titanium nitride, silicon carbide, silicon nitride, and a mixture thereof. A thickness of the first doped diamond-like carbon layer is in the range from 2 nanometers to 60 nanometers.

The gas used in sputtering the first doped diamond-like carbon layer is a mixture of a first gas and a second gas. The first gas is selected from the group consisting of argon and krypton. The second gas is selected from the group consisting of hydrogen, methane, and acetylene. The amount of the second gas is 5% to 20% of that of the first gas. The gas used in the sputtering of the additive material is argon or krypton.

Preferably, the substrate is rotated during the sputtering, and thus a uniform doped diamond-like carbon layer is achieved and the diamond-like carbon and additive are uniformly distributed in the first doped diamond-like carbon layer.

In step 4, the step 3 is repeated and the content of the additive material is reduced for each repetition of the step, and a multilayer doped diamond-like carbon film composed of a plurality of layers of doped diamond-like carbon layer is stacked on the adhesive layer. The first layer is formed on the adhesive layer, then a second layer, a third layer, and so on to an Nth layer. The additive material in each doped diamond-like carbon layer gradually decreases from the first layer to the Nth layer.

In step 5, an undoped diamond-like carbon layer is formed on the multilayer doped diamond-like carbon film. Thus, an article with multilayer diamond-like carbon film is achieved.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. An article comprising:
a substrate;
an adhesive layer formed on the substrate, the adhesive layer being comprised of a material selected from the group consisting of chrome, titanium, silicon, chromium nitride, titanium nitride, and silicon carbide;
a multilayer doped diamond-like carbon film formed on the adhesive layer; the multilayer doped diamond-like carbon film comprising a plurality of doped diamond-like carbon layers stacked one on another, each doped diamond-like carbon layer being comprised of diamond-like carbon and an additive material selected from a group consisting of chrome, titanium, silicon, chromium nitride, titanium nitride, silicon carbide, silicon nitride, and any combination thereof; a content of the additive material in each doped diamond-like carbon layer gradually decreasing with increasing distance away from the substrate; and an undoped diamond-like carbon layer formed on the multilayer doped diamond-like carbon film.

2. The article as claimed in claim 1, wherein a number of the doped diamond-like carbon layers are in the range from 5 to 30.

3. The overcoat as claimed in claim 1, wherein the molar content of the additive material in each doped diamond-like carbon layer is in the range from 0.2% to 1%.

4. The article as claimed in claim 1, wherein a thickness of each doped diamond-like carbon layer is in the range from 2 nanometers to 60 nanometers.

5. The article as claimed in claim 1, wherein a thickness of the adhesive layer is in the range from 5 nanometers to 20 nanometers.

6. The article as claimed in claim 1, wherein a thickness of the undoped diamond-like carbon layer is in the range from 2 nanometers to 20 nanometers.

7. The article as claimed in claim 1, wherein the material of the substrate is selected from the group consisting of iron-carbon-chrome alloy, iron-carbon-chrome-molybdenum alloy, and iron-carbon-chrome-vanadium alloy.

8. A method for manufacturing an article, comprising:
providing a substrate;
forming an adhesive layer on the substrate, the adhesive layer being comprised of a material selected from the group consisting of chrome, titanium, silicon, chromium nitride, titanium nitride, and silicon carbide;
forming a multilayer doped diamond-like carbon film on the adhesive layer, the multilayer doped diamond-like carbon film comprising a plurality of doped diamond-like carbon layers stacked one on another, each doped diamond-like carbon layer being comprised of diamond-like carbon and an additive material selected from a group consisting of chrome, titanium, silicon, chromium nitride, titanium nitride, silicon carbide, silicon nitride, and any combination thereof, a content of the additive in each doped diamond-like carbon layer gradually decreasing with increasing distance away from the substrate;
forming an undoped diamond-like carbon layer on the multilayer doped diamond-like carbon film.

9. The method as claimed in claim 8, wherein a number of the doped diamond-like carbon layers is in the range from 5 to 30.

10. The method as claimed in claim 8, wherein the molar content of additive in each doped diamond-like carbon layer is in the range from 0.2% to 1%.

11. The method as claimed in claim 9, wherein the adhesive layer is formed by ion beam sputtering.

12. The method as claimed in claim 8, wherein the multilayer doped diamond-like carbon film is formed on the adhesive layer by ion beam sputtering.

13. The method as claimed in claim 12, wherein a first target is utilized to sputter a material therefrom to form the diamond-like carbon in each of the doped diamond-like carbon layers, and a second target is used to sputter a material therefrom so as to form the additive material in each of the doped diamond-like carbon layers.

14. The method as claimed in claim 13, wherein the first target is comprised of graphite or carbon.

15. The method as claimed in claim 13, wherein the second target is comprised of a material selected from the group consisting of chrome, titanium, silicon, chromium nitride, titanium nitride, silicon carbide, silicon nitride, and a mixture thereof.
